(19) United States
(12) Patent Application Publication
(10) Pub. No.: US 2025/0165780 A1
(43) Pub. Date: May 22, 2025

(54) SYSTEMS, METHODS, AND MEDIA FOR TRAINING NEURAL NETWORKS TO SOLVE OPTIMATIZATION PROBLEMS

(71) Applicant: The Trustees of Columbia University in the City of New York, New York, NY (US)

(72) Inventors: Xiaodong Wang, Ramsey, NJ (US); Jeremy Johnston, New York, NY (US); Xiao-Yang Liu, New York, NY (US); Shixun Wu, Riverside, CA (US)

(21) Appl. No.: 18/957,348

(22) Filed: Nov. 22, 2024

Related U.S. Application Data
(60) Provisional application No. 63/602,292, filed on Nov. 22, 2023.

(51) Int. Cl. G06N 3/08

(52) U.S. Cl. CPC G06N 3/08

(57) ABSTRACT

Training neural network(s) (NN(s)) to solve optimization problem (OP) includes: configuring a first NN of the NN(s) with a first set of (FSO) values for NN parameters (NNPs); selecting a FSO training samples (TSs) for training the NN(s); providing the FSO TSs and a FSO first variables to the first NN to produce a FSO first output variables (OVs); evaluating an OP-performance-measuring objective function (OF) based on the FSO TSs and the FSO first OVs to provide a first value of (VO) a performance metric (FVOPM) of the NN(s); updating the NNPs based on the FVOPM; selecting a second set of (SSO) TSs for training the NN(s); providing the SSO TSs and the FSO first OVs to the first NN to produce a SSO first OVs; evaluating the OF based on the SSO TSs and the SSO first OVs to provide a second VO the PM of the NN(s); and updating the NNPs based on the second VO the PM.

### CROSS-REFERENCE TO RELATED APPLICATION

This application claims the benefit of U.S. Provisional Patent Application No. 63/602,292, filed Nov. 22, 2023, which is hereby incorporated by reference herein in its entirety.

### BACKGROUND

Many applications require rapid and accurate optimization solutions in order to most-effectively operate. For example, in modern wireless communications systems, it is necessary to solving optimization problems in real-time in order to most effectively provide communication services.

Existing mechanisms for solving such optimization problems are either too slow or inaccurate.

Accordingly, new mechanisms for solving optimization problems are desirable

### SUMMARY

In accordance with some embodiments, mechanisms, including systems, methods, and media, for training one or more neural networks to solve optimization problems are provided.

In some embodiments, systems for training one or more neural networks to solve an optimization problem are provided, the systems comprising: memory; and at least one hardware processor collectively configured to at least: configure a first neural network of the one or more neural networks with a first set of values for first neural network parameters; select a first set of training samples for training the one or more neural networks; provide the first set of training samples and a first set of first variables to the first neural network to produce a first set of first output variables; evaluate an objective function that measures performance on the optimization problem based on the first set of training samples and the first set of first output variables to provide a first value of a performance metric of the one or more neural networks; update the first neural network parameters based on the first value of the performance metric; select a second set of training samples for training the one or more neural networks; provide the second set of training samples and the first set of first output variables to the first neural network to produce a second set of first output variables; evaluate the objective function that measures performance on the optimization problem based on the second set of training samples and the second set of first output variables to provide a second value of the performance metric of the one or more neural networks; and update the first neural network parameters based on the second value of the performance metric. In some of these embodiments, the at least one hardware processor if further collectively configured to: configure a second neural network of the one or more neural networks with a first set of values for second neural network parameters; provide the first set of training samples, a first set of second variables, and the first set of first output variables to the second neural network to produce a first set of second output variables; and update the second neural network parameters based on the first value of the performance metric, wherein providing the first set of training samples and the first set of first variables to the first neural network to produce the first set of first output variables includes providing the first set of second variables to the first neural network, wherein evaluating the objective function that measures performance on the optimization problem based on the first set of training samples and the first set of first output variables to provide the first value of the performance metric of the one or more neural networks is also based on the first set of second output variables. In some of these embodiments, the first neural network and the second neural network have the same architecture. In some of these embodiments: selecting the first set of training samples comprises determining that the first set of training samples has a first level of complexity; and the at least one hardware processor if further collectively configured to: select a third set of training samples determined as having a second level of complexity that is greater than the first level of complexity; and train the one or more neural networks using the third set of training samples. In some of these embodiments, the objective function has a first level of complexity; and the at least one hardware processor if further collectively configured to train the one or more neural networks using an objective function that is determined to be more complex than the first level of complexity. In some of these embodiments, the performance metric is based on a sum of the objective function. In some of these embodiments, the optimization problem is to select optimal beamformers and wherein the method further comprises setting beamformers of a communication system based on the the second set of first output variables.

In some of embodiments, methods for training one or more neural networks to solve an optimization problem are provided, the methods comprising: configuring a first neural network of the one or more neural networks with a first set of values for first neural network parameters; selecting a first set of training samples for training the one or more neural networks; providing the first set of training samples and a first set of first variables to the first neural network to produce a first set of first output variables; evaluating an objective function that measures performance on the optimization problem based on the first set of training samples and the first set of first output variables to provide a first value of a performance metric of the one or more neural networks; updating the first neural network parameters based on the first value of the performance metric using a hardware processor; selecting a second set of training samples for training the one or more neural networks; providing the second set of training samples and the first set of first output variables to the first neural network to produce a second set of first output variables; evaluating the objective function that measures performance on the optimization problem based on the second set of training samples and the second set of first output variables to provide a second value of the performance metric of the one or more neural networks; and updating the first neural network parameters based on the second value of the performance metric. In some of these embodiments, the method further comprises: configuring a second neural network of the one or more neural networks with a first set of values for second neural network parameters; providing the first set of training samples, a first set of second variables, and the first set of first output variables to the second neural network to produce a first set of second output variables; and updating the second neural network parameters based on the first value of the performance metric, wherein providing the first set of training samples and the first set of first variables to the first neural network to produce the first set of first output variables includes providing the first set of second variables to the first neural network, wherein evaluating the objective function that measures performance on the optimization problem based on the first set of training samples and the first set of first output variables to provide the first value of the performance metric of the one or more neural networks is also based on the first set of second output variables. In some of these embodiments, the first neural network and the second neural network have the same architecture. In some of these embodiments: selecting the first set of training samples comprises determining that the first set of training samples has a first level of complexity; and the method further comprises: selecting a third set of training samples determined as having a second level of complexity that is greater than the first level of complexity; and training the one or more neural networks using the third set of training samples. In some of these embodiments: the objective function has a first level of complexity, and the method further comprises training the one or more neural networks using an objective function that is determined to be more complex than the first level of complexity. In some of these embodiments, the performance metric is based on a sum of the objective function. In some of these embodiments, the optimization problem is to select optimal beamformers and wherein the method further comprises setting beamformers of a communication system based on the the second set of first output variables.

In some of embodiments, non-transitory computer-readable medium containing computer executable instructions that, when executed by a processor, cause the processor to perform a method for training one or more neural networks to solve an optimization problem are provided, the method comprising: configuring a first neural network of the one or more neural networks with a first set of values for first neural network parameters; selecting a first set of training samples for training the one or more neural networks; providing the first set of training samples and a first set of first variables to the first neural network to produce a first set of first output variables; evaluating an objective function that measures performance on the optimization problem based on the first set of training samples and the first set of first output variables to provide a first value of a performance metric of the one or more neural networks; updating the first neural network parameters based on the first value of the performance metric; selecting a second set of training samples for training the one or more neural networks; providing the second set of training samples and the first set of first output variables to the first neural network to produce a second set of first output variables; evaluating the objective function that measures performance on the optimization problem based on the second set of training samples and the second set of first output variables to provide a second value of the performance metric of the one or more neural networks; and updating the first neural network parameters based on the second value of the performance metric. In some of these embodiments, the method further comprises: configuring a second neural network of the one or more neural networks with a first set of values for second neural network parameters; providing the first set of training samples, a first set of second variables, and the first set of first output variables to the second neural network to produce a first set of second output variables; and updating the second neural network parameters based on the first value of the performance metric, wherein providing the first set of training samples and the first set of first variables to the first neural network to produce the first set of first output variables includes providing the first set of second variables to the first neural network, wherein evaluating the objective function that measures performance on the optimization problem based on the first set of training samples and the first set of first output variables to provide the first value of the performance metric of the one or more neural networks is also based on the first set of second output variables. In some of these embodiments, the first neural network and the second neural network have the same architecture. In some of these embodiments: selecting the first set of training samples comprises determining that the first set of training samples has a first level of complexity; and the method further comprises: selecting a third set of training samples determined as having a second level of complexity that is greater than the first level of complexity; and training the one or more neural networks using the third set of training samples. In some of these embodiments: the objective function has a first level of complexity, and the method further comprises training the one or more neural networks using an objective function that is determined to be more complex than the first level of complexity. In some of these embodiments, the performance metric is based on a sum of the objective function. In some of these embodiments, the optimization problem is to select optimal beamformers and wherein the method further comprises setting beamformers of a communication system based on the the second set of first output variables.

### BRIEF DESCRIPTION OF THE DRAWINGS

FIG. 1 is an illustration of a first example architecture for learning to optimize that can be used in accordance with some embodiments.

FIG. 2 is an illustration of a first example algorithm for learning to optimize that can be used in accordance with some embodiments.

FIG. 3 is an illustration of a second example architecture for learning to optimize that can be used in accordance with some embodiments.

FIG. 4 is an illustration of a second example algorithm for learning to optimize that can be used in accordance with some embodiments.

FIG. 5 is an illustration of a third example algorithm for learning to optimize that can be used in accordance with some embodiments.

FIG. 6 is an illustration of a fourth example algorithm for learning to optimize that can be used in accordance with some embodiments.

FIG. 7 is an illustration of an example architecture for a neural network that can be used in accordance with some embodiments.

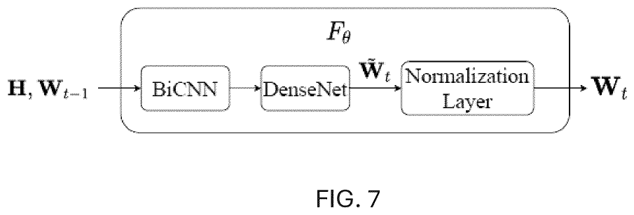

FIG. 8 is an illustration of example hardware that can be used in accordance with some embodiments.

### DETAILED DESCRIPTION

Consider a family of optimization problems:

$$P = \{ {maximum}_{x ∈ {ℝ}^{n}} R ( s , x ) \vert s ∈ {ℝ}^{m} \}$$

where R: [symbol] × [symbol] → [symbol] is the objective, s∈ [symbol] is a parameter that specifies the problem instance, and x∈ [symbol] is the decision variable. In accordance with some embodiments, mechanisms, including systems, methods, and media for solving such problems are provided. More particularly, in accordance with some embodiments, mechanisms, including systems, methods, and media, for rapidly solving such problems in order to enable some real-time application, such as communication or control, are provided.

In some embodiments, iterative algorithms can be used to solve such problems. In some embodiments, iterative optimization entails application of a sequence of functions hₜ: [symbol] × [symbol] → [symbol] , t=1, 2, . . . , where each hₜ maps s and a candidate point xₜ to a new point xₜ₊₁:=hₜ(s, xₜ) and is designed such that the sequence {xₜ} converges to a maximizer of R(s, x) for all s. The recurrence is a composite mapping designed to approach or approximate a solution mapping:

$${x}^{*} ( s ) = {arg max}_{x} R ( s , x ) . \qquad ( 1 )$$

In accordance with some embodiments, a goal is to learn an operator F_{θ}: [symbol] × [symbol] > [symbol] , that can be referred to as an optimizer, that approximates the optimal mapping (1) for all s, thereby embedding in F_{θ} the set of all solutions of the problem family [symbol] . This can be referred to herein as “learning to optimize”.

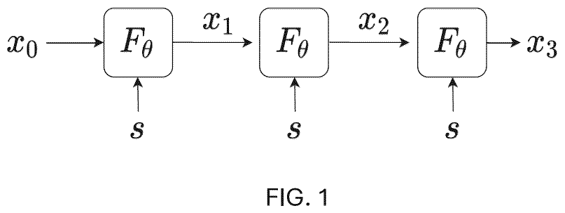

In some embodiments, F_{θ} is a neural network with learnable parameters θ. In some embodiments, the mapping (1) can be approximated through a recursive application of F_{θ}. Given s and a starting point x₀, F_{θ} can be applied for T steps, yielding xₜ:=F_{θ}(s, xₜ₋₁), t=1, 2, . . . , T, in some embodiments. An example block diagram of this scheme in accordance with some embodiments is shown in FIG. 1 for T=3 iterations. To measure the performance of a given trajectory {xₜ}, the sum of the objective value over the trajectory, Σₜ₌₁^{T}R(s, xₜ), can be used, in some embodiments. If s has distribution pₛ, the objective function can be

$$J ( θ ) := {𝔼}_{s ∼ {p}_{s}} [ {\sum }_{t = 1}^{T} R ( s , {x}_{t} ) ] \qquad ( 2 )$$

and the learning problem can be

$${maximum}_{θ} J ( θ )$$

(to which gradient ascent can be applied, in some embodiments), in some embodiments. Training samples (i.e., problem instances specified by s that belong to [symbol] ) can be obtained through simulation or measurement, in some embodiments. If pₛ is known, then an arbitrary number of samples can be generated, in some embodiments. The starting point x₀ can be chosen either heuristically or randomly (or pseudo-randomly) for each s, in some embodiments. Although the quantity of interest is the final objective value, R(s, x_{T}), such a metric would ignore the intermediate values; summation over the entire trajectory, on the other hand, encourages each step to improve the objective.

Learning θ in effect “amortizes” the computational cost of optimization across all problem instances, shifting the computational burden from online optimization to offline learning, in some embodiments. In some embodiments, in deployment of the learned model, an optimization problem can be instantiated by s, then s can be fed to the model which outputs a near-optimal solution for that problem instance. Since the model execution entails just feedforward computation of the model, optimization can be done repeatedly and rapidly, in some embodiments.

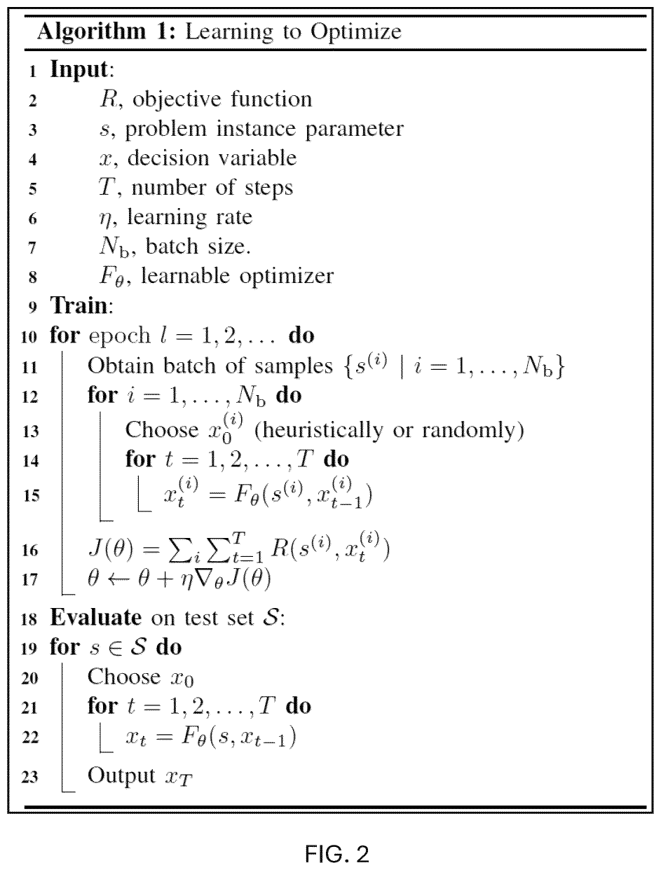

An overall example of a procedure for learning to optimize is summarized in Algorithm 1 of FIG. 2, in accordance with some embodiments. In this example, the target family [symbol] is specified by an objective function R with parameter s∈ [symbol] . In each epoch shown in lines 10-17 of the Algorithm, the iteration xₜ:=F_{θ}(s, xₜ₋₁) is carried out at line 15 for t=1, 2, . . . , T and the cumulative objective value J is computed at line 16. Finally, a gradient step updates θ at line 17. At test time, as shown in lines 18-23, for a given problem instantiated by s, xₜ:=F_{θ}(s, xₜ₋₁) is applied for t=1, 2, . . . , T and a final iterate x_{T} is returned at line 23.

Analogous to the common practice of varying the hyperparameters of an iterative optimization algorithm as the iterations progress, the parameter θ may in general be allowed to vary with t, in some embodiments. When θ is free to vary with respect to t, the optimizer can be referred to as being “untied”; Algorithm 1 as shown in FIG. 2 addresses a “tied” optimizer. The optimal parameters at t=1 need not be the same as some later step, say t=5. Allowing the parameters to vary may grant more expressive capacity. For an untied optimizer in Algorithm 1, F_{θ} can be replaced with a sequence of optimizers F_{θ}, t=1, . . . , T; hence line 15 of Algorithm 1 becomes:

$${x}_{t}^{( i )} = {F}_{{θ}_{t}} ( {s}^{( i )} , {x}_{t - 1}^{( i )} ) .$$

In some embodiments, learning to optimize can be extended to problems where block coordinate optimization is appropriate. In some embodiments, a block coordinate approach splits the optimization variable into subsets and iteratively optimizes over each subset while holding the others fixed. If x=(y, z) is a partition of the optimization variable, the subproblems at iteration t have the form:

$${y}_{t} = {arg max}_{y} R ( s , y , {z}_{t - 1} ) \qquad ( 3 )$$

$${z}_{t} = {arg max}_{z} R ( s , {y}_{t} , z ) \qquad ( 4 )$$

In some embodiments, this approach can be used to efficiently solve convex problems. In some embodiments, even if R is nonconvex, the subproblems may be tractable or admit closed-form solutions, thus providing an efficient means of finding a local optimum.

In some embodiments, two optimizers can be learned to learn the optimal mappings in (3) and (4). The rationale is twofold: a nonconvex objective may become simplified when certain coordinates are held constant; and splitting the optimization variable reduces the dimension of the output space of each policy which, by mitigating the curse of dimensionality, reduces the desired mapping's complexity.

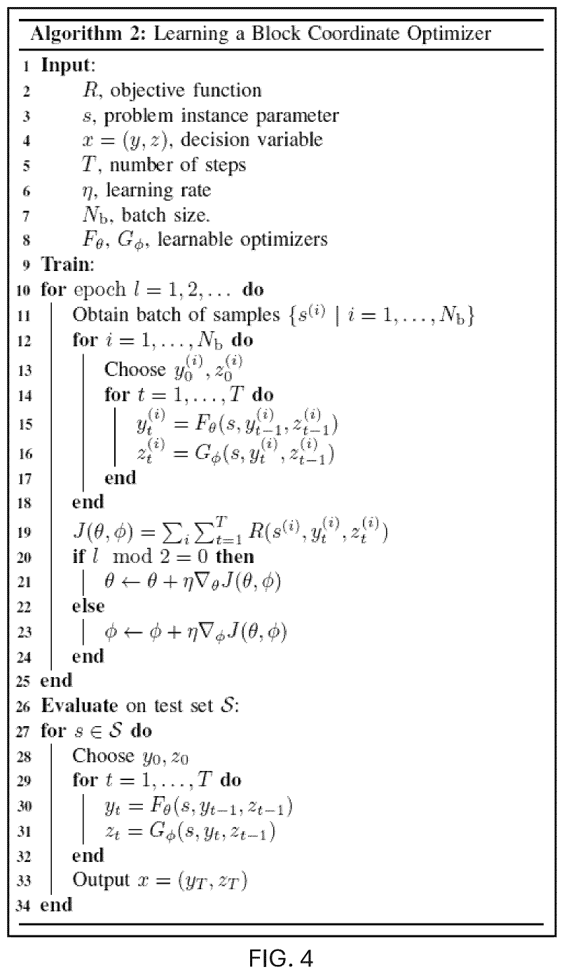

An example procedure for doing so is summarized in Algorithm 2 of FIG. 4. Let F_{θ} and Go denote optimizers which output candidate points y and z, respectively. In some embodiments, the following alternating scheme can be used to iteratively compute yₜ and zₜ for t=1, . . . , T:

$$\begin{matrix}{y}_{t} = {F}_{θ} ( s , {y}_{t - 1} , {z}_{t - 1} ) \\ {z}_{t} = {G}_{ϕ} ( s , {y}_{t} , {z}_{t - 1} )\end{matrix}$$

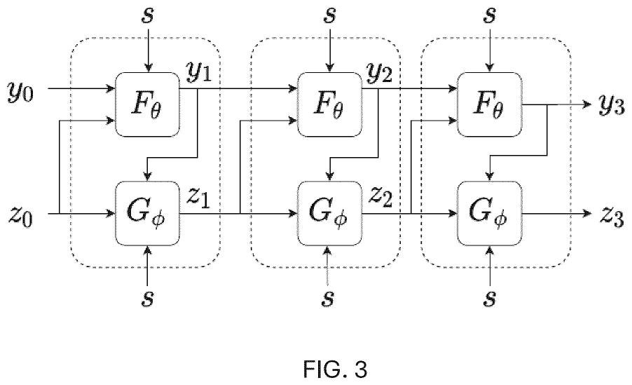

An example block diagram of this scheme in accordance with some embodiments is shown in FIG. 3 for T=3 iterations. As in the single-variable case (shown in FIG. 1), the average sum of the objective values obtained over the iterations can be expressed as:

$$J ( θ , ϕ ) := {𝔼}_{s ∼ {p}_{s}} [ {\sum }_{t = 1}^{T} R ( s , {y}_{t} , {z}_{t} ) ] . \qquad ( 5 )$$

In some embodiments, equation (5) can be employed as a training objective function in order to learn the optimizer parameters θ and ϕ, which may be optimized via block coordinate optimization (as described above) as well. That is, at epoch 1, a gradient step for ϕ can be performed, at epoch 2, θ can be updated, at epoch 3, ϕ can be updated, and so on. To obtain a warm start for each optimizer, F_{θ} (or G_{ϕ}) may be separately pretrained via (3) (or (4)) by fixing z (or y).

In accordance with some embodiments, curriculum learning techniques can be used to learn the solution to the above-described optimization problems. In some embodiments, curriculum learning trains a model on a sequence of tasks of increasing difficulty. Each task can be defined by a particular training objective function and a particular training data distribution, in some embodiments. In some embodiments, the sequence of tasks can increase in difficulty, in that the loss functions become successively more complex and/or that the entropy of the data distributions increases as the curriculum progresses. In some embodiments, rather than solely learning a primary task, these techniques can first perform a first round of learning in which an easier subordinate task is learned, and then perform one or more subsequent rounds of learning based on a neural network produced in the previous round until training converges to a point in parameter space that might be unreachable had training solely been on the primary task.

In accordance with some embodiments, two examples of curriculum learning techniques that can be used with Algorithms 1 and 2 are described below. The first curriculum learning technique, which is referred to herein as a subspace curriculum learning technique, uses a fixed training objective and prescribes a sequence of training data distributions of increasing complexity. The second curriculum learning technique, which is referred to herein as a reward curriculum learning technique, uses a fixed training distribution and prescribes a sequence of training objectives of increasing complexity.

In accordance with some embodiments, the subspace curriculum learning technique curates the training data (problem instances) seen by the optimizer over the course of training. At each stage, in some embodiments, it samples from distributions of increasing entropy and therefore learns tasks of increasing difficulty. Observe that the distribution pₛ affects the difficulty of maximizing (2). In some embodiments, for a zero-entropy distribution pₛ(s)=δ(s−s₀) where s∈ [symbol] is known, only a single output has to be learned, namely

$${arg max}_{x} {R}_{1} ( {s}_{0} , x ) .$$

In some embodiments, the subspace curriculum learning technique prescribes that, during each stage of the curriculum, the training data is restricted to a linear subspace of the state space [symbol] . That is, in some embodiments, the optimizer is trained on a sequence of tasks corresponding to the problem families

$${P}_{d} = \{ {maximum}_{x ∈ {ℝ}^{m}} R ( s , x ) \vert s ∈ {S}_{d} \}$$

for d=1, 2, . . . , m where S_{d}⊂ [symbol] is a d-dimensional subspace. Since S₁⊂S₂⊂ . . . ⊂ [symbol] , then [symbol] ₁⊂ [symbol] ₂⊂ . . . C⊂ [symbol] ₘ; so the complexity of the problem family increases with d. The entropy of the distribution increases with d, since the dimension of the sample space increases with d; for example, with p_{α,d}= [symbol] (0, I), the entropy can be given by d(1+log 2π)/2+(log d)/2, which is increasing in d.

In some embodiments, the subspaces are generated via a particular orthonormal basis {b₁, . . . , bₘ}⊂ [symbol] chosen prior to training, such that S_{d}:=span ({b₁, . . . , b_{d}}). If the subspace dimension is d, training samples can be generated via s=Σᵢ₌₁^{d}α_{i,d}bᵢ, where the coefficients α_{i,d}∈ [symbol] are sampled from a chosen distribution p_{α,d}, in some embodiments.

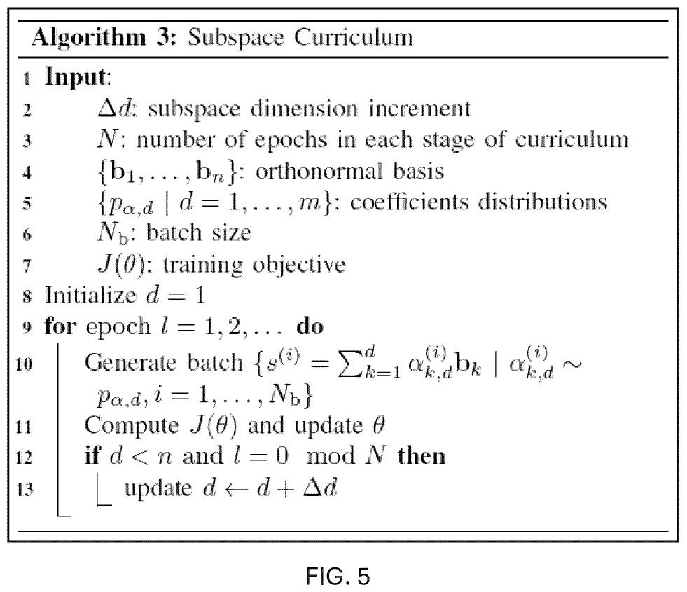

An example application of the subspace curriculum in a general learning environment is illustrated in Algorithm 3 of FIG. 5. Assume a training objective J(θ) where θ denotes the learnable model parameters. Before training begins, a random (or pseudo-random) orthonormal basis {b₁, . . . , bₘ} (which induces the subspaces of [symbol] in which training samples will reside) can be generated, in some embodiments. In some embodiments, the subspace dimension d=1 is initialized at line 8 and the subspace dimension d is incremented every N epochs at lines 12-13. Thus, in some embodiments, for the first N epochs at lines 9-13, all training samples lie on the line induced by basis vector b₁, i.e., the samples are generated according to s=α_{1,1}b₁, where α_{1,1}˜p_{α,1}. In some embodiments, after N epochs, the subspace dimension is increased to d=2 at lines 12-13, so that, in the following N epochs, training samples are generated at line 10 via s=α_{1,2}b₁+α_{2,2}b₂, where α_{1,2}, α_{2,2}˜p_{α,2}. In some embodiments, after N*(m−1) epochs, the subspace dimension is d=m, at which point the training samples span [symbol] .

Since the subspace curriculum learning technique affects only the training data, it can be incorporated into various learning algorithms, in some embodiments. For example, in some embodiments, in Algorithm 1, one would only need to modify the training sample generation at line 11 to incorporate the subspace curriculum learning technique.

Suppose there are two objective functions: R₁: [symbol] × [symbol] > [symbol] and R₂: [symbol] × [symbol] > [symbol] corresponding to two distinct tasks such that the point

$${arg max}_{x} {R}_{1} ( s , x )$$

obtains a reasonably good objective value R₂ for all s. In some embodiments, θ can first be learned for the family of problems

$${P}_{1} = \{ {maximum}_{x ∈ {ℝ}^{m}} {R}_{1} ( s , x ) \vert s ∈ {ℝ}^{m} \}$$

using the training objective J₁:= [symbol] _{s˜p}_{ₛ}[Σₜ₌₁^{T}R₁(s, xₜ)]. A second family of problems can be expressed as

$${P}_{2} = \{ {maximum}_{x ∈ {ℝ}^{m}} {R}_{2} ( s , x ) \vert s ∈ {ℝ}^{m} \}$$

and this family of problems can use the training objective J₂:= [symbol] _{s˜p}_{ₛ}[Σₜ₌₁^{T}R₂(s, xₜ)].

If the optimizer converges to a point θ₁, then starting from θ₁ training can continue with primary task objective J₂:= [symbol] _{s˜p}_{ₛ}[Σₜ₌₁^{T}R₂(s, xₜ)] until convergence, in some embodiments. In some embodiments, θ₁ may be suboptimal with respect to [symbol] ₂, but nonetheless may provide a warm start that ultimately leads to a point superior to that which would be obtained via training solely with J₂. Moreover, if R₁ is a relatively simple function (e.g., quadratic in x), then it stands to reason that the mapping

$${arg max}_{x} {R}_{1} ( s , x )$$

will be simpler and θ will converge quickly, in some embodiments.

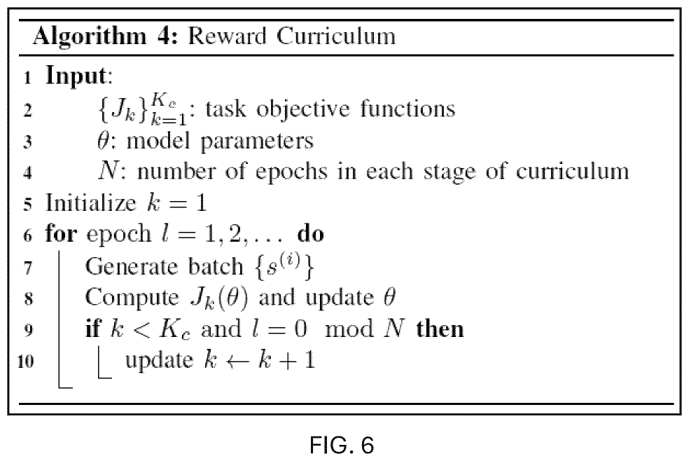

Algorithm 4 of FIG. 6 demonstrates an example application of a reward curriculum learning technique in a general learning environment. It is assumed that there are K_{c} task objective functions

$${\{ {J}_{k} \}}_{k = 1}^{{K}_{c}}$$

such that the task difficulty increases with k and the desired task is represented by the final objective function J_{K}_{_{c}}.

As illustrated in Algorithm 4, in some embodiments, training begins by initializing k=1 at line 5 and thus J₁ serves as the initial training objective. In each epoch in lines 6-10, a batch of samples are obtained at line 7 and then a gradient update is performed using J₁ at line 8. After N epochs, the task index is incremented to k=2 at lines 9-10 and J₂ is used as the training objective function. After N*(K_{c}−1) epochs, k=K_{c} and the final task objective J_{K}_{_{c}} is used for the remainder of training.

In some embodiments, the reward curriculum learning technique can be applied to Algorithm 1 by modifying the training objective in line 16 according to the curriculum over the course of training.

Downlink beamforming is a fundamental technology in multiuser wireless communication that allows simultaneous transmission of multiple data streams from a base station (BS) to multiple users using the same time-frequency resource. The BS is equipped with an antenna array whose complex amplitudes are to be configured so that the transmitted signals add constructively in certain spatial directions and destructively in others, thereby enabling spatial multiplexing of user data streams. A particular configuration of amplitudes is called a beamformer. Each beamformer has sidelobes that interfere with other users, therefore the beamformers should be optimized jointly so as to maximize a performance function that quantifies desired system behavior. For example, the minimum user rate is an objective that promotes fairness among users and thus can be used as a performance metric in some embodiments. As another example, to achieve the best overall system performance, the weighted sum of the user rates can be used as a performance metric in some embodiments.

In accordance with some embodiments, the learning to optimize techniques described above (including Algorithms 1-4) can be applied to, for example, three beamforming scenarios: MISO, MIMO and relay. In some embodiments, this requires four main steps: (1) design the optimizer neural network architecture; (2) define a problem family with objective function R corresponding to a system performance criterion; (3) formulate an iterative scheme that outputs beamformers for given channels where the iterative operator is a learnable optimizer; and (4) devise a training procedure to learn the optimizer parameters such that the iterative scheme approaches the optimal channel-beamformer mapping.

In some embodiments, the learning to optimize techniques described above (including Algorithms 1-4) can be used to configure a multiple-input, single-output radio (MISO) communication system. When these techniques are used, in some embodiments, s described above can be equal to H below, x described above can be equal to W described below, and R described above can be equal to R(H, W).

Consider an N-antenna base station (BS) that communicates with K single-antenna users. The BS applies transmit beamformer wᵢ∈ [symbol] to the ith user data stream, so that, if xᵢ∈ [symbol] is the symbol intended for user i, the transmitted signal is Σᵢ₌₁^{K}wᵢwᵢ. Let hₖ denote the channel between the BS and user k (a user herein is a device with a receiver and/or transmitter), so that user k receives the signal

$${y}_{k} = {h}_{k}^{H} {\sum }_{i = 1}^{K} {x}_{i} {w}_{i} + {n}_{k} , k = 1 , … , K$$

where nₖ˜ [symbol] (0, σ²) is additive noise. User k's signal-to-interference-plus-noise ratio can be expressed as:

$${SINR}_{k} = \frac{{\vert {h}_{k}^{H} {w}_{k} \vert}^{2}}{{σ}^{2} + {\sum }_{i \neq k} {\vert {h}_{K}^{H} {W}_{i} \vert}^{2}} .$$

The MISO beamforming problem can be formulated as

$$\begin{matrix}{maximum}_{{w}_{1} , … , {w}_{K}} f ( {r}_{1} , … , {r}_{k} ) \\ subject to {\sum }_{k = 1}^{K} {‖ {w}_{k} ‖}_{2}^{2} \leq P\end{matrix} \qquad ( 6 )$$

where ƒ: [symbol] → [symbol] is the system performance function and rₖ:=log₂(1+SINRₖ) is the achievable information rate of user k.

In accordance with some embodiments, (6) can be solved by applying Algorithm 1 as described below.

Let s=[h₁ . . . h_{K}]^{H}:=H∈ [symbol] and x=[w₁ . . . w_{K}]:=W∈ [symbol] . The optimization problem class is

$$P = \{ {maximum}_{\begin{matrix}w ∈ {ℂ}^{N \times K} \\ {‖ W ‖}_{F}^{2} = P\end{matrix}} {R}_{2} ( H , W ) \} ,$$

where R: [symbol] ^{N×K}× [symbol] ^{N×K}Θ [symbol] is the performance criterion (ƒ in (6)). The learnable optimizer is denoted F_{θ}: [symbol] ^{N×K}× [symbol] ^{N×K}→ [symbol] ^{N×K} with learnable parameters θ. The beamformers are iteratively computed via

$${W}_{t + 1} := {F}_{θ} ( H , {W}_{t} ) ] \qquad ( 8 )$$

and the training objective is

$$J ( θ ) = {𝔼}_{H ∼ {p}_{H}} [ {\sum }_{t = 1}^{T} R ( H , {W}_{t} ) ] \qquad ( 8 )$$

where p_{H} is the channel distribution. In each epoch, a batch of channels is generated with SNR ρ_{H}² (the SNR can be made to vary from sample to sample so that the optimizer is trained on a range of SNRs as described above). For each sample in the batch, Algorithm 1 can carry out the iteration (7) for T steps, compute the corresponding cumulative loss (8) and perform a gradient step for θ.

In some embodiments, at least one of the above-described reward curriculum learning technique and the subspace curriculum learning technique can be used to obtain beamformers.

For example, a reward curriculum learning technique can be implemented as follows.

In some embodiments, minimum mean square error (MMSE) beamformers achieve a reasonably good sum rate and min rate, and the mean square error (MSE) objective is simply quadratic in W.

In some embodiments, linear MMSE beamformers can be given by

$${W}_{k} = \sqrt{{p}_{k}} \frac{{( {σ}^{2} {I}_{N} + {\sum }_{i = 1}^{K} \frac{P}{K} {h}_{i} {h}_{i}^{H} )}^{- 1} * {h}_{k}}{{‖ {( {σ}^{2} {I}_{N} + {\sum }_{i = 1}^{K} \frac{P}{K} {h}_{i} {h}_{i}^{H} )}^{- 1} * {h}_{k} ‖}_{2}}$$

where {pₖ} are transmit powers. In some embodiments, assume equal power allocation, pₖ=P=K.

In some embodiments, the MSE can be defined as MSE(H, W):= [symbol] [∥HWx+n−x∥₂²], where expectation is with respect to the noise n˜ [symbol] (0, σ²I) and data vector x˜ [symbol] (0,I).

In some embodiments, the MMSE optimization problem can be

$${maximize}_{\begin{matrix}W ∈ {ℂ}^{N \times K} \\ {‖ W ‖}_{F}^{2} = P\end{matrix}} MSE ( H , W ) .$$

In some embodiments, to compute the MSE, the objective can be empirically evaluated via sampling independent and identically distribute (i.i.d.) vectors x and n, or the analytical expression MSE(H, W)=∥HW∥_{F}²−2Re{trace(HW)} can be used.

In terms of Algorithm 4, the reward curriculum technique can define the task loss R₁:=MSE and R₂ can be the desired performance criterion (e.g., sum rate, min rate).

For example, a subspace curriculum learning technique can be implemented as follows.

Assuming p_{H}˜ [symbol] (0,1), an arbitrary number of training samples can be generated and the training data can be curated according to the subspace curriculum. To implement subspace curriculum learning, the orthonormal basis vectors {b₁, . . . , bₙ} of [symbol] can be randomly (or pseudo-randomly) generated and the distributions {p_{α,d}|d=1, . . . , m} which are used to generate samples in a given subspace can be set to p_{α,d}= [symbol] (0,1) for all d. For the MISO problem, the full channel space is [symbol] , hence n=2NK.

In some embodiments, the learning to optimize techniques described above (including Algorithms 1-4) can be used to configure beamforming in a multiple-input, multiple-output radio (MIMO) communication systems. When these techniques are used, in some embodiments, s described above can be equal to {Hₖ} below, x described above can be equal to {Wₖ} described below, and R described above can be equal to R ({Hₖ}, {Wₖ}).

In the MIMO case, in some embodiments, each user is equipped with a receive antenna array capable of receive beamforming, or spatially filtering the impinging waveform, and hence may perform additional interference cancellation, thereby relaxing the transmit beamforming requirements.

Suppose the BS has N transmit antennas and user k has mₖ receive antennas. The symbol xₖ∈ [symbol] is intended for user k and the BS applies the beamformers Wₖ∈ [symbol] , so that the tranmitted signal is Σₖ₌₁^{K} Wₖxₖ. If Hₖ∈ [symbol] is user k's channel matrix, then user k's array measurement Yₖ=[Y_{k,1} . . . Y_{k,m}_{ₖ}]^{T}∈ [symbol] has the form Yₖ=Hₖ^{H}Σᵢ₌₁^{K}Wᵢxᵢ+nₖ, or

$${Y}_{k} = {H}_{k}^{H} {W}_{k} {x}_{k} + {H}_{k}^{H} {{\sum }^{K}}_{i \neq k} {W}_{i} {x}_{i} + {n}_{k}$$

Define Σₖ∈ [symbol] , the covariance matrix of the interference-plus-noise term,

$${\sum }_{k} = {σ}^{2} I + {H}_{k}^{H} ( {\sum }_{i \neq k}^{K} {W}_{i} {W}_{i}^{H} ) {H}_{k} .$$

Then the rate of user k is

$${r}_{k} = {log}_{2} \vert I + {\sum }_{k}^{- 1} {H}_{k}^{H} {W}_{k} {W}_{k}^{H} {H}_{k} \vert$$

and the beamformer design problem can then be (in some embodiments):

$$\begin{matrix}{maximize}_{{W}_{1} , … {W}_{K}} f ( {r}_{1} , … , {r}_{k} ) \\ subject to {\sum }_{i = 1}^{K} {‖ {W}_{i} ‖}_{F}^{2} \leq P .\end{matrix}$$

In this example, the class of resource allocation problems under consideration can then be (in some embodiments):

$$P = \{ {maximize}_{\begin{matrix}{W}_{k} ∈ {ℂ}^{N \times {m}_{k}} \\ {\sum }_{k} {‖ {W}_{k} ‖}_{F}^{2} = P\end{matrix}} R ( \{ {H}_{k} \} , \{ {W}_{k} \} ) \} ,$$

where R: [symbol] × [symbol] → [symbol] is the performance criterion and Hₖ∈ [symbol] . In this case, in some embodiments, Algorithm 1 can be applied by defining s:=(H₁, . . . , H_{K}), x:=(W₁, . . . , W_{K}) and the objective function as follows: R({Hₖ}, {Wₖ})=Σₖ₌₁^{K} log₂|I+Σₖ⁻¹Hₖ^{H}WₖWₖ^{H}Hₖ|.

In some embodiments, the learning to optimize techniques described above (including Algorithms 1-4) can be used to configure relay beamforming in a multiple-input, multiple-output radio (MIMO) communication system. When these techniques are used, in some embodiments, s described above can be equal to {H,G} below, x described above can be equal to {F, W} described below, and R described above can be equal to R(H, G, F, W).

Consider a scenario in which there is an M-antenna relay station (RS) between the N-antenna BS and the single-antenna users. Let G∈ [symbol] be the MIMO channel matrix between the BS and the RS and let hₖ∈ [symbol] be the channel vector between the RS and user k. The transmitted signal from the BS is Σₖ₌₁^{K}x_{K}wₖ. Denote the BS beamformers W=[W₁ . . . . Wₖ]∈ [symbol] .

The received signal at the RS can be given by z=G Σₖ₌₁^{K}xₖwₖ+v∈ [symbol] where v˜ [symbol] (0,σᵣ²). The RS can employ a transmit beamforming matrix F∈ [symbol] and forward the signal Fz∈ [symbol] to the users. The received signal at user k can be written as

$$\begin{matrix}{y}_{k} = {h}_{k}^{H} Fz + {n}_{k} , or \\ {y}_{k} = {h}_{k}^{H} {FGw}_{k} {x}_{k} + {\sum }_{l \neq k} {h}_{k}^{H} {FGw}_{l} {x}_{l} + {h}_{k}^{H} Fv + {n}_{k}\end{matrix}$$

where nₖ˜ [symbol] (0,σᵣ²), in some embodiments, the SINR of user k is

$${SINR}_{k} = \frac{{\vert {h}_{k}^{H} {FGw}_{k} \vert}^{2}}{{\sum }_{l \neq k} {\vert {h}_{k}^{H} {FGw}_{l} \vert}^{2} + {‖ {h}_{k}^{H} F ‖}_{2}^{2} {σ}_{r}^{2} + {σ}^{2}} \qquad ( 9 )$$

and the user rates are given by rₖ:=log₂(1+SINRₖ), in some embodiments. The goal is to choose beamformers W and F to maximize a performance function ƒ subject to transmit power constraints at the BS and RS:

$$\begin{matrix}{maximize}_{W , F} f ( {r}_{1} , … , {r}_{k} ) \\ \begin{matrix}subject to & {‖ W ‖}_{F}^{2} \leq {P}_{b} \\ & {‖ F ‖}_{F}^{2} \leq {P}_{r} .\end{matrix}\end{matrix} \qquad ( 10 )$$

In accordance with some embodiments, (10) can be solved using the learning to optimize techniques described above as follows.

In some embodiments, the class of resource allocation problems under consideration can be

$$P = \{ {maximize}_{\begin{matrix}F ∈ {ℂ}^{M \times M} , W ∈ {ℂ}^{N \times K} \\ {‖ W ‖}_{F}^{2} = {P}_{b} , {‖ F ‖}_{F}^{2} = {P}_{r}\end{matrix}} R ( H , G , F , W ) \} ,$$

where H∈ [symbol] , G∈ [symbol] , and the performance criterion R is the sum rate as

$$R ( H , G , F , W ) = {\sum }_{k = 1}^{K} {log}_{2} ( 1 + {SINR}_{k} )$$

where SINRₖ is given by (9) below.

In some embodiments, when applying Algorithm 2 to this optimization problem, F_{θ} and G_{ϕ} are defined as optimizers and variables y:=W and z:=F given s:=(H,G) are alternatively selected.

When F is fixed, in some embodiments, the task of selecting W is equivalent to that of the MISO downlink beamforming problem described above with the channel matrix set equal to the effective channel \tilde{H}:=HFG.

When W is fixed, in some embodiments, the task is to choose relay beamformers F given the BS relay channel H and the relay-user effective channel GW.

In some embodiments, the beamformers can be computed by alternating between the two optimizers for t=1, . . . , T:

$$\begin{matrix}{W}_{t , 0} = {W}_{t - 1 , {T}_{W}} \\ {F}_{t , 0} = {F}_{t - 1 , {T}_{F}} \\ {\tilde{H}}_{t} = {HF}_{t , 0} G \\ {W}_{t , k} = {F}_{θ} ( {\tilde{H}}_{t} , {W}_{t , k - 1} ) , k = 1 , … , {T}_{W} \\ {F}_{t , k} = {G}_{ϕ} ( {GW}_{t , {T}_{W}} , H , {F}_{t , k - 1} ) , k = 1 , … , {T}_{F} ,\end{matrix}$$

where unrolled F_{θ} and G_{ϕ} have been unrolled for T_{F} and T_{G} steps, respectively. F_{0;T}_{_{F}} is set equal to I/\sqrt{M} and W_{0,T}_{_{F}} is set equal to HG/∥HG∥_{F}. The input to F_{θ} is analogous to that of the MISO optimizer describe above, where \tilde{H}ₜ serves as the BS-user channel, but a key difference is that here the channel varies with t since it depends on the choice of Fₜ. The inputs of G_{ϕ} include GWₜ (the effective channel between the relay and the users) along with H and Fₜ. The training objective is defined as

$$J ( θ , ϕ ) = [ 𝔼 [ {\sum }_{t = 1}^{T} {\sum }_{k = 1}^{{T}_{W}} R ( H , G , {F}_{t , 0} , {W}_{t , k} ) ] + {\sum }_{l = 1}^{{T}_{F}} R ( H , G , {F}_{t , l} , {W}_{t , {T}_{W}} ) ] .$$

Since for fixed F the problem has the same structure has the MISO scenario, F_{θ} may be pretrained as a MISO beamforming optimizer (as described above) so that it outputs the optimal W for any given \tilde{H}. Having initialized F_{θ}, Algorithm 2 can then be applied.

In some embodiments, Algorithms 1-4 can be implemented using an optimizer with any suitable neural network architecture. For example, in some embodiments, the neural network architecture can include any function that: has parameters to be learned; and is a composition of linear and nonlinear functions (which can be referred to as “layers” or “activations”). In some embodiments, examples of layers (can be linear or nonlinear) can include: convolution layers-used in convolutional neural network (CNN); fully connected layers-used in multilayer perceptron (MLP); attention layers-used in the “Transformer” architecture; and message passing layers-used in graph neural networks (GNN). In some embodiments, examples of activations (nonlinear only) can include: rectified linear unit (ReLU); sigmoid function (logistic function); and hyperbolic tangent (tanh).

In some embodiments, for the beamforming applications, a neural network architecture including biconvolutional neural network (BiCNN), a DenseNet, and a normalization layer can be used.

FIG. 5 shows an example of such a neural network for the MISO application described above, in accordance with embodiment some embodiments. As illustrated in this figure, the inputs to F_{θ} are H (or s in Algorithms 1-4) and Wₜ₋₁ (or xₜ₋₁ in Algorithms 1-4) and the output is Wₜ (or xₜ in Algorithms 1-4). In some embodiments, any suitable number (e.g., three as shown in FIG. 1) of the F_{θ} from FIG. 5 can arranged in series in a configuration as shown in FIG. 1. Likewise, in some embodiments, the Fe shown in FIG. 5 can be used to implement F_{θ} and G_{ϕ} shown in FIG. 3.

In some embodiments, the BiCNN performs feature extraction on the network input. Convolution exploits the translation invariance of the input along both user and antenna dimensions, since for any ordering of input channel vectors the optimal beamformers are the same (up to a permutation of the user indices) and vice versa, in some embodiments.

In some embodiments, the DenseNet module mirrors the original DenseNet architecture, except that the convolutional layers are replaced by fully connected layers.

In some embodiments, each beamforming scenario includes a constraint on the transmit power. This constraint can be enforced by appending a normalization layer to the network. In particular, suppose \tilde{W}∈ [symbol] is the beamformer matrix produced by the DenseNet module. Then, for a given transmit power P, the normalization layer can output W=\sqrt{P}\tilde{W}/∥\tilde{W}∥_{F} so that the output satisfies ∥W∥_{F}²=P.

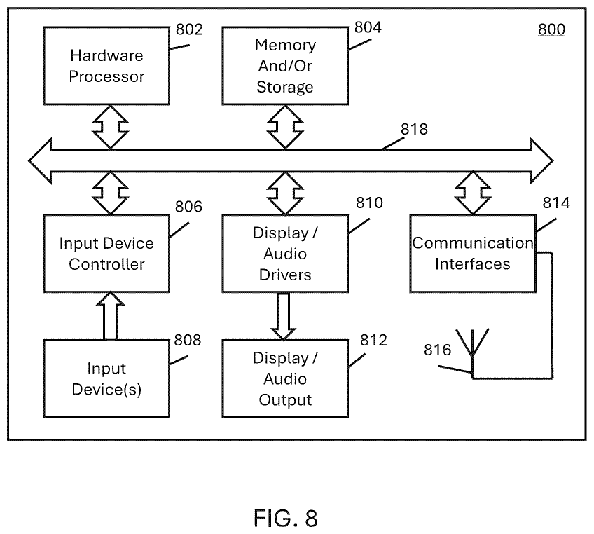

The above-described mechanisms for solving optimization problems can be perform on any suitable general-purpose computer or special-purpose computer. Any such general-purpose computer or special-purpose computer can include any suitable hardware. For example, as illustrated in example hardware 800 of FIG. 8, such hardware can include hardware processor 802, memory and/or storage 804, an input device controller 806, an input device 808, display/audio drivers 810, display and audio output circuitry 812, communication interface(s) 814, an antenna 816, and a bus 818.

Hardware processor 802 can include any suitable hardware processor, such as a microprocessor, a micro-controller, digital signal processor(s), dedicated logic, and/or any other suitable circuitry for controlling the functioning of a general-purpose computer or a special purpose computer in some embodiments.

Memory and/or storage 804 can be any suitable memory and/or storage for storing programs, data, and/or any other suitable information in some embodiments. For example, memory and/or storage 804 can include random access memory, read-only memory, flash memory, hard disk storage, optical media, and/or any other suitable memory.

Input device controller 806 can be any suitable circuitry for controlling and receiving input from input device(s) 808 in some embodiments. For example, input device controller 806 can be circuitry for receiving input from an input device 808, such as a touch screen, from one or more buttons, from a voice recognition circuit, from a microphone, from a camera, from an optical sensor, from an accelerometer, from a temperature sensor, from a near field sensor, and/or any other type of input device.

Display/audio drivers 810 can be any suitable circuitry for controlling and driving output to one or more display/audio output circuitries 812 in some embodiments. For example, display/audio drivers 810 can be circuitry for driving one or more display/audio output circuitries 812, such as an LCD display, a speaker, an LED, or any other type of output device.

Communication interface(s) 814 can be any suitable circuitry for interfacing with one or more communication networks. For example, interface(s) 814 can include network interface card circuitry, wireless communication circuitry, and/or any other suitable type of communication network circuitry.

Antenna 816 can be any suitable one or more antennas for wirelessly communicating with a communication network in some embodiments. In some embodiments, antenna 816 can be omitted when not needed.

Bus 818 can be any suitable mechanism for communicating between two or more components 802, 804, 806, 810, and 814 in some embodiments.

Any other suitable components can additionally or alternatively be included in hardware 800 in accordance with some embodiments.

It should be understood that at least some of the above-described functions of Algorithms 1-4 can be executed or performed in any order or sequence not limited to the order and sequence shown in and described in the figures. Also, some of the above functions of Algorithms 1-4 can be executed or performed substantially simultaneously where appropriate or in parallel to reduce latency and processing times. Additionally or alternatively, some of the above described functions of Algorithms 1-4 can be omitted.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory magnetic media (such as hard disks, floppy disks, and/or any other suitable magnetic media), non-transitory optical media (such as compact discs, digital video discs, Blu-ray discs, and/or any other suitable optical media), non-transitory semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for training one or more neural networks to solve an optimization problem, comprising:
memory; and
at least one hardware processor collectively configured to at least:
configure a first neural network of the one or more neural networks with a first set of values for first neural network parameters;
select a first set of training samples for training the one or more neural networks;
provide the first set of training samples and a first set of first variables to the first neural network to produce a first set of first output variables;
evaluate an objective function that measures performance on the optimization problem based on the first set of training samples and the first set of first output variables to provide a first value of a performance metric of the one or more neural networks;
update the first neural network parameters based on the first value of the performance metric;
select a second set of training samples for training the one or more neural networks;
provide the second set of training samples and the first set of first output variables to the first neural network to produce a second set of first output variables;
evaluate the objective function that measures performance on the optimization problem based on the second set of training samples and the second set of first output variables to provide a second value of the performance metric of the one or more neural networks; and
update the first neural network parameters based on the second value of the performance metric.

2. The system of claim 1, wherein the at least one hardware processor if further collectively configured to:
configure a second neural network of the one or more neural networks with a first set of values for second neural network parameters;
provide the first set of training samples, a first set of second variables, and the first set of first output variables to the second neural network to produce a first set of second output variables; and
update the second neural network parameters based on the first value of the performance metric,
wherein providing the first set of training samples and the first set of first variables to the first neural network to produce the first set of first output variables includes providing the first set of second variables to the first neural network,
wherein evaluating the objective function that measures performance on the optimization problem based on the first set of training samples and the first set of first output variables to provide the first value of the performance metric of the one or more neural networks is also based on the first set of second output variables.

3. The system of claim 2, wherein the first neural network and the second neural network have the same architecture.

4. The system of claim 1,
wherein selecting the first set of training samples comprises determining that the first set of training samples has a first level of complexity, and
wherein the at least one hardware processor if further collectively configured to:
select a third set of training samples determined as having a second level of complexity that is greater than the first level of complexity; and
train the one or more neural networks using the third set of training samples.

5. The system of claim 1,
wherein the objective function has a first level of complexity, and
wherein the at least one hardware processor if further collectively configured to train the one or more neural networks using an objective function that is determined to be more complex than the first level of complexity.

6. The system of claim 1, wherein the performance metric is based on a sum of the objective function.

7. The system of claim 1, wherein the optimization problem is to select optimal beamformers and wherein the method further comprises setting beamformers of a communication system based on the the second set of first output variables.

8. A method for training one or more neural networks to solve an optimization problem, comprising:
configuring a first neural network of the one or more neural networks with a first set of values for first neural network parameters;
selecting a first set of training samples for training the one or more neural networks;
providing the first set of training samples and a first set of first variables to the first neural network to produce a first set of first output variables;
evaluating an objective function that measures performance on the optimization problem based on the first set of training samples and the first set of first output variables to provide a first value of a performance metric of the one or more neural networks;
updating the first neural network parameters based on the first value of the performance metric using a hardware processor;
selecting a second set of training samples for training the one or more neural networks;
providing the second set of training samples and the first set of first output variables to the first neural network to produce a second set of first output variables;
evaluating the objective function that measures performance on the optimization problem based on the second set of training samples and the second set of first output variables to provide a second value of the performance metric of the one or more neural networks; and
updating the first neural network parameters based on the second value of the performance metric.

9. The method of claim 8, further comprising:
configuring a second neural network of the one or more neural networks with a first set of values for second neural network parameters;
providing the first set of training samples, a first set of second variables, and the first set of first output variables to the second neural network to produce a first set of second output variables; and
updating the second neural network parameters based on the first value of the performance metric,
wherein providing the first set of training samples and the first set of first variables to the first neural network to produce the first set of first output variables includes providing the first set of second variables to the first neural network,
wherein evaluating the objective function that measures performance on the optimization problem based on the first set of training samples and the first set of first output variables to provide the first value of the performance metric of the one or more neural networks is also based on the first set of second output variables.

10. The method of claim 9, wherein the first neural network and the second neural network have the same architecture.

11. The method of claim 8,
wherein selecting the first set of training samples comprises determining that the first set of training samples has a first level of complexity, and
wherein the method further comprises:
selecting a third set of training samples determined as having a second level of complexity that is greater than the first level of complexity; and
training the one or more neural networks using the third set of training samples.

12. The method of claim 8,
wherein the objective function has a first level of complexity, and
wherein the method further comprises training the one or more neural networks using an objective function that is determined to be more complex than the first level of complexity.

13. The method of claim 8, wherein the performance metric is based on a sum of the objective function.

14. The method of claim 8, wherein the optimization problem is to select optimal beamformers and wherein the method further comprises setting beamformers of a communication system based on the the second set of first output variables.

15. A non-transitory computer-readable medium containing computer executable instructions that, when executed by a processor, cause the processor to perform a method for training one or more neural networks to solve an optimization problem, the method comprising:
configuring a first neural network of the one or more neural networks with a first set of values for first neural network parameters;
selecting a first set of training samples for training the one or more neural networks;
providing the first set of training samples and a first set of first variables to the first neural network to produce a first set of first output variables;
evaluating an objective function that measures performance on the optimization problem based on the first set of training samples and the first set of first output variables to provide a first value of a performance metric of the one or more neural networks;
updating the first neural network parameters based on the first value of the performance metric;
selecting a second set of training samples for training the one or more neural networks;
providing the second set of training samples and the first set of first output variables to the first neural network to produce a second set of first output variables;
evaluating the objective function that measures performance on the optimization problem based on the second set of training samples and the second set of first output variables to provide a second value of the performance metric of the one or more neural networks; and
updating the first neural network parameters based on the second value of the performance metric.

16. The non-transitory computer-readable medium of claim 15, wherein the method further comprises:
configuring a second neural network of the one or more neural networks with a first set of values for second neural network parameters;
providing the first set of training samples, a first set of second variables, and the first set of first output variables to the second neural network to produce a first set of second output variables; and
updating the second neural network parameters based on the first value of the performance metric,
wherein providing the first set of training samples and the first set of first variables to the first neural network to produce the first set of first output variables includes providing the first set of second variables to the first neural network,
wherein evaluating the objective function that measures performance on the optimization problem based on the first set of training samples and the first set of first output variables to provide the first value of the performance metric of the one or more neural networks is also based on the first set of second output variables.

17. The non-transitory computer-readable medium of claim 16, wherein the first neural network and the second neural network have the same architecture.

18. The non-transitory computer-readable medium of claim 15,
wherein selecting the first set of training samples comprises determining that the first set of training samples has a first level of complexity, and
wherein the method further comprises:
selecting a third set of training samples determined as having a second level of complexity that is greater than the first level of complexity; and
training the one or more neural networks using the third set of training samples.

19. The non-transitory computer-readable medium of claim 15,
wherein the objective function has a first level of complexity, and
wherein the method further comprises training the one or more neural networks using an objective function that is determined to be more complex than the first level of complexity.

20. The non-transitory computer-readable medium of claim 15, wherein the performance metric is based on a sum of the objective function.

21. The non-transitory computer-readable medium of claim 15, wherein the optimization problem is to select optimal beamformers and wherein the method further comprises setting beamformers of a communication system based on the the second set of first output variables.
